(19) United States
(12) Patent Application Publication
(10) Pub. No.: US 2005/0289035 A1
(43) Pub. Date: Dec. 29, 2005

(54) Method for providing multiple electronic fixed income securities inventory platforms on a single website for viewing by the public

(76) Inventor: James W. Korth, Coconut Grove, FL (US)

Correspondence Address: FELDMANGALE, P.A., MIAMI CENTER, 19TH FLOOR, 201 SOUTH BISCAYNE BOULEVARD, MIAMI, FL, 33131, US

(21) Appl. No.: 11/167,668

(22) Filed: Jun. 27, 2005

Related U.S. Application Data
(60) Provisional application No. 60/583,956, filed on Jun. 28, 2004.

(51) Int. Cl. G06F 17/60

(52) U.S. Cl. 705/35

(57) ABSTRACT

A method for providing multiple electronic fixed income securities inventory platforms on a single website for viewing by the public makes available to the public on single Internet site multiple unique electronic fixed income securities inventory platforms. On-line electronic fixed-income securities inventory platforms offering and selling fixed income securities are located and identifies. The fixed-income securities have characteristics. On-line locations of a subset of the located and identified electronic fixed-income securities inventory platforms are cataloged in a database. Inquiries from on-line customers regarding fixed-income securities including at least one customer-desired characteristic of the fixed-income securities are received. Summary information relating to the fixed-income securities dependent upon the at least one customer-desired characteristic is formed. The summary information is transmitted to the customer.

### CROSS-REFERENCE TO RELATED APPLICATION

This application claims the priority, under 35 U.S.C. § 119, of U.S. Provisional Patent Application No. 60/583,956 filed Jun. 28, 2004, the entire disclosure of this prior application is hereby incorporated herein by reference in its entirety.

### BACKGROUND OF THE INVENTION

### FIELD OF THE INVENTION

The present invention pertains to the offer and sale of fixed income securities (defined herein to mean any note, bond, treasury bond, debenture, floating rate notes, mortgage back bonds or notes, collateralized mortgage obligations, certificate of deposit, foreign bond, preferred shares or any other evidence of indebtedness) to the public through electronic platforms generally viewed from computer based systems. Electronic fixed income securities platforms are defined to mean Internet or intranet based systems where multiple separate offers or bids (where the participant wants to buy a fixed income product) are “posted” at any given time from securities issuers, institutional investors, individual investors or dealers or their respective representatives. Electronic platforms may be sponsored by licensed securities dealers or other not-so-licensed companies. The electronic platforms may be offered to viewers or customers on a closed or intranet electronic system accessible to those who qualify or on an open or Internet electronic system where anyone can view the securities posted there.

Currently there exist several distinct large electronic based fixed income securities systems that incorporate many different types of fixed income securities (e.g., taxable bonds, tax exempt bonds, government bonds, zero coupon bonds, certificates of deposits). There also exist many smaller systems that focus on specific types of fixed income securities (e.g., only certificates of deposit or only foreign bonds). On each of these platforms, multiple offers of the same fixed income investment often may appear at varying prices and, at the same time. Each system often has fixed income securities not available on other systems. There are specific reasons for such separation and prior art systems, platforms, websites, and/or databases intentionally keep the information segregated. One reason is that large financial dealers have typically invested in consortiums to offer a particular electronic platform for their needs, while smaller dealers use a single, privately sponsored platform. Providing a unique platform different from competitor and investing in platforms offering different and unique products is a valued goal to distinguish the offerer from their competitors. Further, to keep investors from going elsewhere, dealers generally want the customer to believe that the inventory shown on their website is unique to that dealer. Placing multiple programs on a single dealer site, therefore, could encourage the customers to seek other competitors' sources. As such, the existing seller/dealer platforms are directed towards uniqueness and non-consolidation. Finally, seller-provided platforms are, inherently, biased to benefit the seller. Consequently, it would be beneficial buyers of fixed income securities to have a better chance to find the securities they want and the best price by providing simple access to multiple systems.

Prior to the present invention, no Internet or intranet portal offered more than one large electronic inventory system. Consequently, viewers needed to go from portal to portal to find securities that best met their specific needs or to find the best offering prices for a given security. Accordingly, it would be beneficial to provide portal that offers to the fixed income security buyer a large inventory from a myriad of sources.

### SUMMARY OF THE INVENTION

It is accordingly an object of the invention to provide a method for providing multiple electronic fixed income securities inventory platforms on a single website for viewing by the public that overcomes the hereinafore-mentioned disadvantages of the heretofore-known devices and methods of this general type and that makes multiple bond inventory electronic databases available to viewers on a single Internet or intranet based aggregation website.

The present invention is novel over the prior art because, while there are currently many unique electronic platforms, there is no single website where multiple electronic platforms can be viewed and analyzed. In contrast to the prior art of providing unique platforms different from competitors and investing in platforms offering different and unique products, the present invention takes a completely different approach and puts a huge amount of inventory on one site. The present invention clearly discloses to the customer that the inventory is from multiple sources and encourages customers to employ its advantages because of the ease of use.

The present invention can be implemented by organizing an Internet site in a way not previously thought. It was learned from a survey of customers that these investors were jumping around from website to website with different large electronic platforms to find securities that suited them at the best price. These customers/investors currently buy securities in multiple places, but complain of the added bookkeeping. The present invention offers a single process accessing a large number of different electronic platforms and offering it to investors as if it was a single inventory. By interviewing the customers as to their needs, the present invention can survey all of the platforms and customize offerings to the individual customer's requirements.

Further, a study was conducted and found that it was not just perception by investors that caused them to search from website to website. It was discovered that the platforms professing to sell different investments at unique prices actually were selling the same securities but at different offering amounts, sale terms, and prices.

To get the information to investors on one website, the present invention provides two solutions. The first solution provides an interface page at which investors can simply pick which platform they would like to view at any given time. The second solution can extract all of the offerings and prices available and aggregate them in a separate presentation encompassing all the offerings of the multiple systems. From a regulatory standpoint the United States Securities and Exchange Commission has put forth a policy of more open disclosure of information regarding the pricing and markets for fixed income securities. Each of the embodiments of the present invention appears to be in line with this policy.

With the foregoing and other objects in view, there is provided, in accordance with the invention, a computerized method for aggregating electronic fixed-income securities inventory platforms, includes locating and identifying on-line electronic fixed-income securities inventory platforms offering and selling fixed income securities. These fixed-income securities have characteristics. On-line locations of at least a subset of the located and identified electronic fixed-income securities inventory platforms are cataloged in a database. Inquiries from on-line customers regarding fixed-income securities are received. The inquiries include at least one customer-desired characteristic of the fixed-income securities. Summary information relating to the fixed-income securities dependent upon the at least one customer-desired characteristic is formed. This summary information is transmitted to the customer.

The characteristics of the fixed-income securities can include source, CUSIP number, amount offered, minimum amount for sale, price, description, yield, maturity, name, term, amount offered, interest rate, investment ratings, location of issuer, and specific nature of the instruments.

With the objects of the invention in view, there is also provided a machine readable medium having instructions stored thereon for execution by a processor to perform a method for aggregating electronic fixed-income securities inventory platforms. The method includes locating and identifying on-line electronic fixed-income securities inventory platforms offering and selling fixed income securities. These fixed-income securities have characteristics. On-line locations of at least a subset of the located and identified electronic fixed-income securities inventory platforms are cataloged in a database. Inquiries from on-line customers regarding fixed-income securities including at least one customer-desired characteristic of the fixed-income securities are received. Summary information relating to the fixed-income securities dependent upon the at least one customer-desired characteristic is formed. The summary information is transmitted to the customer.

With the objects of the invention in view, in a computer system having a graphical user interface including a display and a selection device, there is also provided a method for aggregating electronic fixed-income securities inventory platforms. The method includes locating and identifying on-line electronic fixed-income securities inventory platforms offering and selling fixed income securities. The fixed-income securities have characteristics. On-line locations of at least a subset of the located and identified electronic fixed-income securities inventory platforms are cataloged in a database. A customer inquiry entry form is displayed on the display. An inquiry selection signal indicative of the selection device pointing at a selected customer inquiry response from an on-line customer regarding fixed-income securities including at least one customer-desired characteristic of the fixed-income securities is received. In response to the signal, summary information relating to the fixed-income securities dependent upon the at least one customer-desired characteristic is formed and the summary information is displayed to the customer on the display.

In accordance with another mode of the invention, the locating and identifying step is carried by periodically searching each of the electronic fixed-income platforms and gathering pre-defined information from the platforms.

In accordance with a further mode of the invention, the cataloging step is carried out by aggregating the pre-defined information into the database.

In accordance with an added mode of the invention, the database is connected to a network accessible by the customers and a search engine is provided to the customer for searching the database. The search engine has the ability to search the database alphabetically, numerically, and/or based upon the characteristics.

In accordance with an additional mode of the invention, the receiving step is provided by receiving search commands from the customers based upon the characteristics.

In accordance with yet another mode of the invention, the fixed-income securities are selected from municipal bonds, corporate bonds, mortgage bonds, and treasury bonds.

In accordance with yet a further mode of the invention, the database is associated with a given website and the receiving and transmitting steps are carried out through the website.

In accordance with yet an added mode of the invention, the customers are interviewed regarding fixed-income securities needs by transmitting at least one query to the customer. The receiving step is carried out by receiving at least one response from the customer to the query. The forming step is carried out by surveying at least one of the fixed-income securities platforms for information associated with the at least one response, gathering the associated information, and customizing the gathered information to form the summary information.

In accordance with yet an additional mode of the invention, the summary information is maintained in a memory.

In accordance with again another mode of the invention, the database is located at a given location and inquiries are received from on-line customers located at locations different from the given location.

In accordance with again a further mode of the invention, the summary information includes at least one web address of at least one electronic fixed-income securities inventory platform.

In accordance with again an added mode of the invention, the transmitting step is carried out by transmitting the at least one web address.

In accordance with again an additional mode of the invention, the summary information is delivered in a private label format.

In accordance with still another mode of the invention, the summary information can be delivered to viewers by providing separate links on an aggregation site for viewers to visit each system separately.

In accordance with a concomitant mode of the invention, a behind-the-scenes program can combine the offerings of separate electronic fixed income platforms into a single super-large database.

Other features that are considered as characteristic for the invention are set forth in the appended claims.

Although the invention is illustrated and described herein as embodied in a method for providing multiple electronic fixed income securities inventory platforms on a single website for viewing by the public, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a diagrammatic representation of a representative intranet or Internet website page used in the method according to the invention; and

FIGS. 2 to 4 are diagrammatic representations of search results created by the method according to the invention from different electronic platforms for General Motors Acceptance Corporation fixed income securities due between Aug. 15, 2007 and Dec. 10, 2007.

### DESCRIPTION OF THE PREFERRED EMBODIMENTS

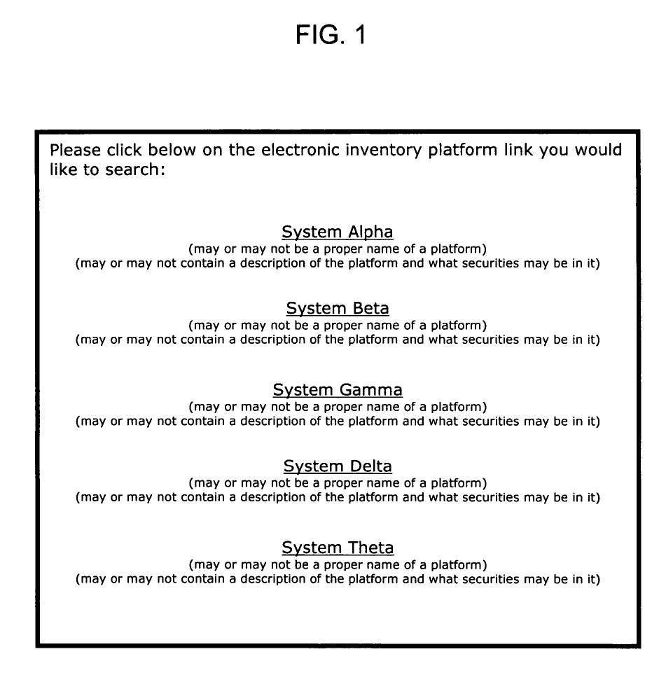

Referring now to the figures of the drawings in detail and first, particularly to FIG. 1 thereof, there is shown a representation of a web page that can contain links or buttons to have viewers use their computer pointer device (e.g., mouse) or any other electronic measures to see different electronic fixed income inventory platforms existing on the World Wide Web. An example of this interface page may be found at the www.shop4bonds.com website, where Internet users can select between large electronic platforms to search for fixed income securities.

To get the information to investors on one website, the present invention provides two solutions.

The first is explained with regard to the interface page shown in FIG. 1. Here investors can simply pick which platform they would like to view at any given time. It is noted that only five example platforms are shown in FIG. 1, but this number could be many more.

The second solution is to extract all the offerings and prices and aggregate them in a separate presentation encompassing all the offerings of the multiple systems. This aggregation can take place in a variety of ways. One exemplary manner for aggregation can first include setting up, on an Internet server, separate electronic registers for each sub-type of fixed income securities (this may include any type of organization such as: municipal bonds, corporate bonds, mortgage bonds, treasury bonds).

Then, the system periodically electronically searches each separate large electronic fixed income platform by security type and gathers certain pre-defined information, which may include more than the following characteristics of the securities: source, CUSIP number, amount offered, minimum amount for sale, price, and description.

Lastly, the information is aggregated into a single database that is made accessible by viewers in any way. For example, the database can be searchable by security yield, maturity, or name, in alphabetical form, by the terms of bonds, by the amount offered or the interest rate.

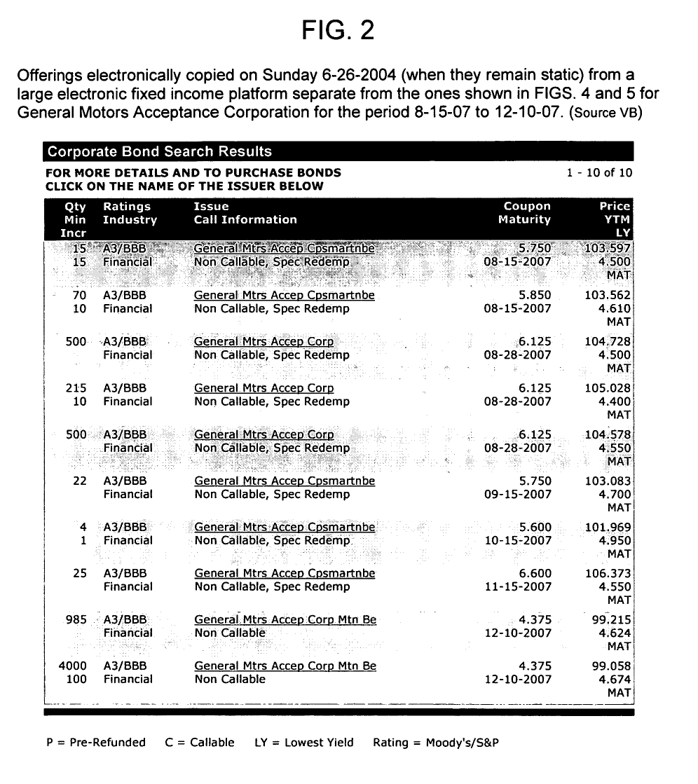

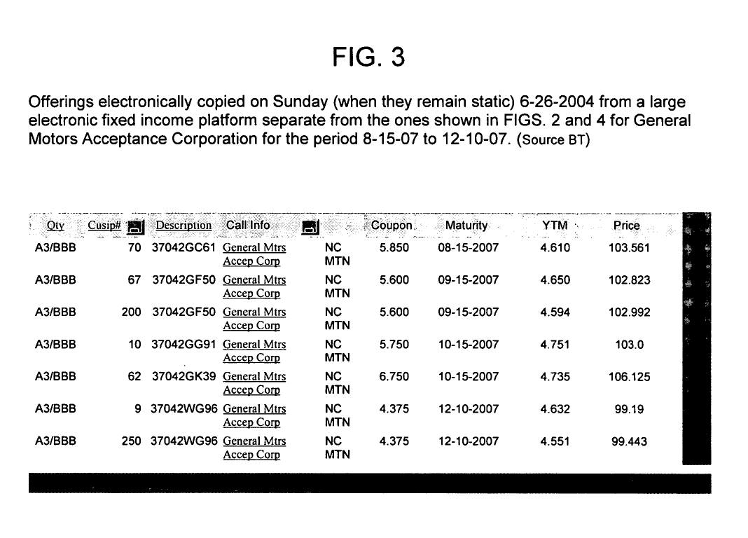

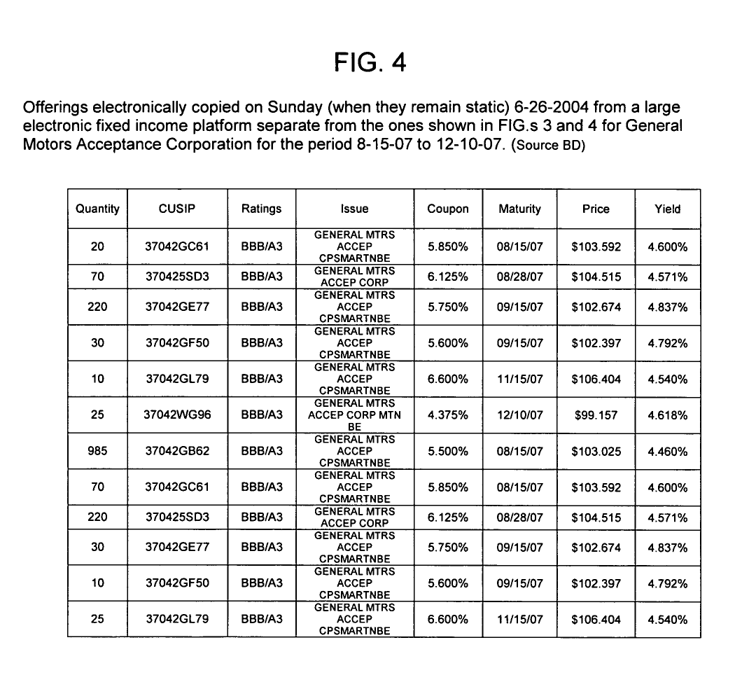

FIGS. 2, 3, and 4, respectively, show, in diagrammatic form, search results from different electronic platforms for General Motors Acceptance Corporation (“GMAC”) fixed income securities due between Aug. 15, 2007 and Dec. 10, 2007. In FIGS. 2 to 4, the presentations are different. More importantly, some of exactly the same GMAC securities appear at different prices. Also, different GMAC securities appear in each of the platforms. To get the highest yield for GMAC notes, the investor would find 4.95% on FIG. 2, but that note yield is only for $4,000 face amount of the bonds. To get the highest yield on a $25,000 face amount, the investor would find 4.83% on FIG. 4. If an investor wanted to purchase more than $300,000 of a General Motors Acceptance Corporation bonds with a maturity between Aug. 15, 2007 and Dec. 10, 2007, that investor would have to be able to access the system portrayed on FIG. 2. In another example, if an investor wanted to buy a bond with the highest stated interest rate, that investor would find it at 6.75%, but only on the platform represented by FIG. 3.

Clearly, depending on an investor's objectives, the investor or investment advisor will find his/her best opportunity for investing in General Motors Acceptance Corporation fixed income securities by viewing more than one of these three electronic platforms. The system of the present invention provides such features.

It is noted that the results shown here for only one bond issuer (GMAC) can be replicated for any or all other issuers or other maturities across the large electronic systems.

Prior to the present invention, to fully review the marketplace, investors and advisors needed to have multiple websites available to them often with separate account numbers and passwords. With the present invention, such entities can now use only one location, e.g., website, to save valuable time and find the best fixed income security to meet their specific investment needs. Additionally, the entities can ascertain the best price and terms for that given security.

Currently, most securities dealers require investors to open an account before they can view even a single electronic fixed income platform. Because each dealer only has one electronic platform, they often buy securities at more than one dealer and, then, transfer their securities to a safekeeping dealer. Such an elaborate process requires extra bookkeeping and account management. With the present invention, however, the securities dealers can now maintain one account and view multiple platforms with thousands more offerings from a single dealer.

Multiple electronic fixed income securities platforms may be delivered to the public by a closed electronic system with passwords, and open electronic system without passwords, in the form of emails or other electronic based access. The present invention may be used by a viewer for no charge or with charges. The data from each of the separate large fixed income platforms may be aggregated electronically and can be presented through the single system of the present invention. The databases may be searchable where the viewer can enter specific parameters and get specific results or they may be presented as a mass list organized by any measures, such as alphabetically, numerically, by maturity, by investment ratings, by stated interest rate, by investment yield, by the location of the issuer, or by the specific nature of the instruments, such as registered, bearer, or other forms. The information in the multiple electronic systems may be delivered in a form where the name of the specific inventory system is not disclosed, which is referred to as a “private label” format. The private label format has its appearance electronically manipulated to look like the offerings of a specific source. Alternatively, the inventory may be shown in the state it which it comes from the owner of the electronic platform.

1. A computerized method for aggregating electronic fixed-income securities inventory platforms, which comprises:
locating and identifying on-line electronic fixed-income securities inventory platforms offering and selling fixed income securities, the fixed-income securities having characteristics;
cataloging in a database on-line locations of at least a subset of the located and identified electronic fixed-income securities inventory platforms;
receiving inquiries from on-line customers regarding fixed-income securities including at least one customer-desired characteristic of the fixed-income securities;
forming summary information relating to the fixed-income securities dependent upon the at least one customer-desired characteristic; and
transmitting the summary information to the customer.

2. The method according to claim 1, which further comprises carrying out the locating and identifying step by periodically searching each of the electronic fixed-income platforms and gathering pre-defined information from the platforms.

3. The method according to claim 2, which further comprises carrying out the cataloging step by aggregating the pre-defined information into the database.

4. The method according to claim 1, which further comprises:
connecting the database to a network accessible by the customers; and
providing a search engine to the customer for searching the database.

5. The method according to claim 4, which further comprises carrying out the receiving step by receiving search commands from the customers based upon the characteristics.

6. The method according to claim 4, which further comprises providing the search engine with ability to search the database at least one of alphabetically, numerically, and based upon the characteristics.

7. The method according to claim 1, wherein the fixed-income securities are selected from at least one of the group consisting of municipal bonds, corporate bonds, mortgage bonds, and treasury bonds.

8. The method according to claim 1, which further comprises:
associating the database with a given website; and
carrying out the receiving and transmitting steps through the website.

9. The method according to claim 1, which further comprises:
interviewing the customers regarding fixed-income securities needs by transmitting at least one query to the customer;
carrying out the receiving step by receiving at least one response from the customer to the query; and
carrying out the forming step by:
surveying at least one of the fixed-income securities platforms for information associated with the at least one response;
gathering the associated information; and
customizing the gathered information to form the summary information.

10. The method according to claim 1, which further comprises maintaining the summary information in a memory.

11. The method according to claim 1, which further comprises:
providing the database at a location; and
receiving inquiries from on-line customers located at one or more locations different from the location of the database.

12. The method according to claim 1, wherein the characteristics of the fixed-income securities are selected from at least one of the group consisting of source, CUSIP number, amount offered, minimum amount for sale, price, description, yield, maturity, name, term, amount offered, interest rate, investment ratings, location of issuer, and specific nature of the instruments.

13. The method according to claim 1, wherein the summary information includes at least one web address of at least one electronic fixed-income securities inventory platform.

14. The method according to claim 13, which further comprises carrying out the transmitting step by transmitting the at least one web address.

15. The method according to claim 1, which further comprises delivering the summary information in a private label format.

16. A machine readable medium having instructions stored thereon for execution by a processor to perform a method for aggregating electronic fixed-income securities inventory platforms, the method comprising:
locating and identifying on-line electronic fixed-income securities inventory platforms offering and selling fixed income securities, the fixed-income securities having characteristics;
cataloging in a database on-line locations of at least a subset of the located and identified electronic fixed-income securities inventory platforms;
receiving inquiries from on-line customers regarding fixed-income securities including at least one customer-desired characteristic of the fixed-income securities;
forming summary information relating to the fixed-income securities dependent upon the at least one customer-desired characteristic; and
transmitting the summary information to the customer.

17. In a computer system having a graphical user interface including a display and a selection device, a method for aggregating electronic fixed-income securities inventory platforms, the method comprising:
locating and identifying on-line electronic fixed-income securities inventory platforms offering and selling fixed income securities, the fixed-income securities having characteristics;
cataloging in a database on-line locations of at least a subset of the located and identified electronic fixed-income securities inventory platforms;
displaying a customer inquiry entry form on the display;
receiving an inquiry selection signal indicative of the selection device pointing at a selected customer inquiry response from an on-line customer regarding fixed-income securities including at least one customer-desired characteristic of the fixed-income securities; and
in response to the signal:
forming summary information relating to the fixed-income securities dependent upon the at least one customer-desired characteristic; and
displaying the summary information to the customer on the display.
